(19) United States
(12) Patent Application Publication
(10) Pub. No.: US 2010/0082769 A1
(43) Pub. Date: Apr. 1, 2010

(54) METHOD AND A SYSTEM FOR COMMUNICATION BETWEEN SEPARATE WEB APPLICATIONS

(75) Inventors: Emmanuel Bertin, Luc-Sur-Mer (FR); Nassim Laga, Caen (FR); Jean-Pierre Deschrevel, Putot-En-Bessin (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/567,927

(22) Filed: Sep. 28, 2009

(30) Foreign Application Priority Data
Sep. 30, 2008 (FR) 08 56592

(51) Int. Cl. G06F 9/46; G06F 15/16

(52) U.S. Cl. 709/217; 719/313; 719/330

(57) ABSTRACT

A method of communication between a first application and at least one second application accessible on an Internet browser page. The method comprises: (1) a dynamic subscription step of said first application subscribing to at least one service of said at least one second application; and (2) an execution step of said first application dynamically executing at least one operation taking account of a value of at least one parameter generated by the execution of said at least one service and sent by said second application to said first application.

### CROSS-REFERENCE TO RELATED PATENT APPLICATION

This application claims the benefit of French Patent Application No. 08 56592, filed on Sep. 30, 2008, in the French Institute of Industrial Property, the entire contents of which is incorporated herein by reference.

### FIELD OF THE INVENTION

The present invention relates to a method for dialogue between separate web applications, each executed by a server terminal and displayed simultaneously on the same presentation page, for example an HTML page presented on a computer terminal by a web browser.

### BACKGROUND OF THE INVENTION

Thus the invention enables separate web applications to execute certain operations in response to services implemented by another application with which they cohabit at the display level, on the same web page developed in modular fashion from a plurality of separate and independent modules usually called portlets, widgets, or gadgets.

Such modules or portlets are adapted to serve as containers on a web page for executing and/or displaying web applications and are used in particular to develop web 2.0 services or applications, for example using AJAX (Asynchronous Javascript And XML) techniques.

AJAX is a computer-based method of developing web applications. It is no way a technology in itself, and this term simply refers to the conjoint use of a set of technologies routinely used on the web, including:
HTML (HyperText Markup Language) and XHTML (Extensible HyperText Markup Language) in relation to defining the semantic structure of the information on a web page;
DOM (Document Object Model) and Javascript for displaying and dynamically interacting with the information presented; DOM is a W3C recommendation and is used inter alia to describe an interface that is independent of any programming language and any platform and that enables computer programs and scripts to access or to update the content, structure, or style of documents;
the Javascript (Registered Trade Mark) language, including the object XMLHttpRequest that characterizes the asynchronous side of AJAX, especially but not exclusively in relation to exchanging and manipulating data with a web server; in particular, this object produces data in the XML format and also in the HTML format, or more simply in text format, by invoking simple HTTP (HyperText Transfer Protocol) requests (HTTP is a client-server communications protocol developed for the worldwide web).

Although such portlets enable cohabitation on the same web page of a plurality of application components (referred to below for simplicity as applications) in a manner that can be personalized (in terms of graphics, layout, etc.), they nevertheless have the main drawback of not enabling connectivity and/or interoperability between a plurality of web applications each hosted by a portlet on the same web page, which makes it impossible to make a first application (portlet) respond dynamically to the execution of a service implemented by a second application (portlet), for example.

The term “service” refers to any application function that can generate as output at least one parameter value (by way of non-limiting example an event value or a data value), such parameter values being usable as input parameters for the execution of an operation (another service, a process, etc.) implemented and executed by another application hosted on the same web page (for example a web portal page).

### SUMMARY OF THE INVENTION

The present invention offers a solution that does not have the above-mentioned disadvantages by proposing a method that is, on the contrary, adapted to provide for dynamic communication of information between separate applications hosted on the same web page and dynamic interoperability between such applications, which are often heterogeneous and developed independently of one another, and all this without requiring any action on the part of the user.

To this end, the invention provides a method of communication between a first application and at least one second application accessible on the same. Internet browser page.

According to the invention, the method comprises:
a dynamic subscription step of said first application to at least one service of said at least one second application;
an execution step by said first application executing at least one operation taking account of a value of at least one parameter generated by the execution of said at least one service and sent by said second application to said first application.

Such a method thus has the advantage of favoring dynamic interoperability and communication/exchange of information between web applications (portlets) hosted on the same web page, for example an HTML page, and thereby improving the performance of the service offered to the user.

It further offers the user possibilities of manipulating and interacting much more intuitively with services offered by each application that they can access on the same browser web page.

Implementing a mechanism for a first application to subscribe to at least one service offered by at least one other application, where both applications are hosted on the same web page, makes it possible to create a communications link between at least some of the applications on the same web page. By means of this communications link, these applications can be “aware” of one another and can thus interoperate to the benefit of the user.

In one preferred embodiment of the invention, the value of the parameter generated by the executing said service of the second application is representative of an event or data and can serve as an input parameter for executing said operation.

The proposed solution enables the modules:
to know in real time which applications are loaded by the user; this makes it possible to target portlets to which the parameters (for example events and/or data) are published (i.e. a portlet A can trigger the portlet B to effect a specific task); this has a two-fold advantage, a first in terms of security—the applications know which other applications are able to use the data or events that they generate—and a second in terms of automating communication between applications on the same web page, which enriches the functions offered to a user because of this possibility of interoperability between applications on the same web page; and
to subscribe to service(s) offered by another application, for example either events of predetermined type (e.g. an “incoming call” type event) or data of predetermined type (e.g. “contact” type data).

In particular, once the first application has been subscribed to at least one service of at least one second application, said first application is able to trigger automatically the execution of a predetermined operation that takes account of at least one data value updated by executing said at least one service provided by said second application.

This predetermined data value generated by a service of the second application is communicated dynamically thereby to the first application, which has previously been subscribed to the service, before being acted on by the first application, which triggers the execution of a specific operation using this value as an input parameter.

The transfer of information between web applications hosted on the same web page is then effected directly and dynamically between the applications, once they have been subscribed to respective service(s) (generated data and/or events) of at least one other application.

Thus another advantage of the approach of the invention stems from the fact that it does not involve users knowing in advance what operations need to be effected between said first portlet and said second portlet, which simplifies use and makes using the various services that are offered to them intuitive.

Moreover, it is easy to envisage a variant of the above-mentioned method in which the applications can also subscribe to services implemented by any other module (visible or invisible to the user) hosted on the web page and able to generate or produce a parameter value used thereafter for the execution of said operation executed by the first application. For example, it may be envisaged that, independently of the application hosted on the web page, dynamic information contained in the web page is updated and can be communicated by a module for managing this dynamic information (also hosted on the web page) to applications that use this information as input parameters of operations to be executed.

In one advantageous implementation of the invention, such a communications method includes a prior step of said second application sending a first list to an application management entity, which first list associates each service offered by said second application with at least one parameter of predetermined type for which a value will be generated on execution of said service.

This feature enables a third-party entity responsible for communication between separate applications hosted on an Internet browser web page to list all types of parameters (data or events) that can be generated at the output of an application service implemented and executed in the second application.

Said subscription step preferably comprises the following sub-steps:
registering said first application with an application management entity;
said first application sending said application management entity a second list of parameters respectively associated with at least one operation liable to be executed by said first application;
said management entity creating a third service subscription list by matching parameter types contained in said first and second lists, which third list associates each service from said first list with at least one operation liable to be executed by said first application.

This step of the communications method of the invention is particularly important in that it enables the management entity to match each service from said first list with at least one operation that can be executed by said first application. The matching is effected between the respective types of parameters (data or events) listed in said first and second lists. Such a list, which is updated dynamically as a function of connection/disconnection of applications on the web page and as a function of subscription to and unsubscription from services, is used to create a communications link between applications hosted and executed on the same web page, without them needing to know about one another beforehand and without them needing to have been developed specifically to be able to interact and/or interoperate with one another, which constitutes a clear advantage specific to the present invention.

This third list advantageously serves as a base for triggering an operation (service, process, etc.) executed by the first application, on the basis of a data and/or event value being generated by a service of the second application.

To improve the security of communication between said first and second applications that basically do not “know” each other, criteria of selection and/or control of parameters exchanged between the first and second applications could be verified by the management unit, or even, in one possible embodiment, by the first application, in order to condition execution of said operation on prior verification of said above-mentioned criteria.

In one advantageous implementation of the invention, such a method further comprises a step of creating a communications link between said first and second applications, which communications link is activated from the second application to trigger the execution of said operation by said first application following execution of said service by said second application.

This communications link between the first and second applications is kept active by the application management entity, so that following the generation of a new parameter (data or event) by a service of the second application, a corresponding command to trigger at least one operation (process, service, etc.) taking said new value into account is sent to the first application. Such an approach thus has the advantage of favoring interoperability between applications hosted in separate portlets on the same web page, even though they were developed independently of each other.

In one possible implementation of the method, said communications link set up between the first and second applications is of the remote function call type, taking account of a value of said parameter generated on execution of the service of said second application.

Such a technical approach has the advantage of facilitating implementation of the communications link between applications on the same web page.

It is of course possible to imagine other ways of implementing the communications link, for example relying on Flash (Registered Trade Mark) or Java (Registered Trade Mark) type communication functions.

In one preferred implementation of the method of the invention, said link is an element of a man-machine interface specific to said second application and by means of which a user of said second application can interact to trigger the execution of said specific operation of said first application.

Thus users also have the possibility of triggering the execution of an operation specific to the first application themselves by interacting with an element of the man-machine interface (MMI) specific to the second application and representative of the first application, which tends to make the nature of the interoperability between applications made available to the user somewhat more intuitive.

In said dynamic execution step it is preferably verified that the type of said at least input parameter of said operation corresponds to the type of at least one parameter generated on execution of a service of said second application to which said first application subscribes.

This provides for type checking before execution of an operation by the first application, following the generation of one or more data and/or event values at the time of execution of a service by the second application.

It is of course possible to envisage without restriction any other combination of the above-mentioned characteristics specific to the communications method of the invention, and such other combinations will be within the field of the protection applied for.

The invention also provides a system for communication between a first application and at least one second application hosted on an Internet browser page.

According to the invention, such a system advantageously comprises:
means for dynamic subscribing said first application to at least one service of said at least one second application;
means for executing by said first application of at least one operation taking account of a value of at least one parameter (data or event) generated by the execution of said at least one service and sent by said second application to said first application.

The invention further provides an entity for managing at least one first application and one second application each hosted on an Internet browser page.

According to the invention, such an entity comprises:
means for storing a first list associating each service offered by said second application with at least one type of parameter for which a value will be generated on execution of said service, said second application sending said first list to said entity;
means for storing a second list of parameters respectively associated with at least one operation liable to be executed by said first application, said second list being sent to said entity by said first application;
means for creating a third service subscription list which associates each service from said first list with at least one operation liable to be executed by said first application, said creation means being adapted to match the parameter types contained in said first and second lists.

In a preferred embodiment of the invention, said management entity advantageously further includes:
means for receiving a value of at least one parameter (data or event) generated by said second application executing said at least one service; and
means for sending said value to said first application for dynamic execution of said at least one operation taking account of said value.

This kind of entity can therefore handle:
management of inter-application service subscriptions;
management of communication between applications that have subscribed to their services, independently or mutually.

The invention further provides a computer program product downloadable from a communications network and/or stored on a computer-readable information medium and/or executable by a microprocessor, such a computer program product comprising code instructions for the execution of a communications method as described in detail above when it is executed on a computer.

### BRIEF DESCRIPTION OF THE DRAWINGS

The technical advantages and features of the present invention emerge more clearly from the following description, given by way of non-limiting illustration and with reference to the appended drawings, in which:

FIG. 1 is a flowchart summarizing the main steps of the communications method of the invention;

FIGS. 2A to 2D describe the principle of subscribing applications hosted on the same browser web page to service(s) (data and/or events) proposed by at least some of them;

FIGS. 3A and 3B illustrate the principle of communication between applications on the same web page by the method of the invention.

### DETAILED DESCRIPTION

The present invention proposes a solution favoring communication and exchange of information, and therefore dynamic interoperability, between web applications.

One embodiment of the invention is described in detail below.

In the context of the present invention, an application hosted in a web page has a life cycle that can be summarized as follows:
a first stage in which said application is initialized, essentially based on the following three steps:
   making itself known to other applications (also called portlets) hosted on the same web page;
   subscribing to services liable to generate relevant (event and/or data) parameters; and
   knowing the subscriptions of other applications (data and events to which the other applications can react); this step manages the context in the sense that each application knows all the services that are linked to it and that are loaded by the user;
a second stage during which applications that subscribe to the services of other applications can communicate with one another using a predetermined mode of publication/reception of events and/or data; and
a third stage, initiated on disconnection or interruption of the execution of an application on said web page, of sending disconnection/interruption information to the other applications hosted on the web page so that the applications that remain active on the web page can update their information relating to applications that previously subscribed to one or more of their services but for which execution in the web page has since been interrupted.

These stages specific to the invention are described in detail below.

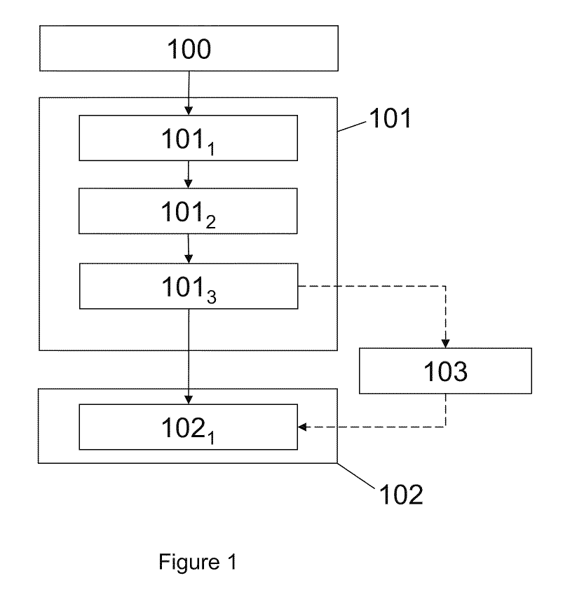

The major steps of the method of communication between applications executed in respective portlets each hosted in the same web page of a browser are summarized below with reference to FIG. 1.

According to the invention, such a method of communication between a first application and at least one second application accessible on an Internet browser page includes:
a step 101 of dynamically subscribing said first application to at least one service of said at least one second application; and
a step 102 of said first application executing at least one operation 102₁ taking into account a value of at least one data and/or event updated by the execution of said at least one service and sent by said second application to said first application.

This method of the invention includes a prior step 100 in which said second application sends an application management entity a first list associating the service offered by said second application with at least one predetermined parameter (data and/or event) for which a value will be generated on executing said service.

Said subscription step 101 comprises the following sub-steps:
registering 101₁ said first application with an application management unit;
said first application sending 101₂ said application management entity a second list of parameter types (data or elements) associated with at least one operation liable to be executed by said first application; and
said management entity creating 101₃ a third service subscription list, during which sub-step each service from said first list is associated with at least one operation liable to be executed by said first application by matching parameter types contained in said first and second lists.

In an advantageous embodiment of the invention, the method includes a step 103 of creating a communications link between said first and second applications, said link being activated by said second application to trigger execution of said operation by said first application following execution of said service by said second application.

In one embodiment of the invention, the dynamic execution step verifies 102 that the type of said at least one input parameter of said operation corresponds to the type of data generated on execution by said second application of a service to which said first application subscribes.

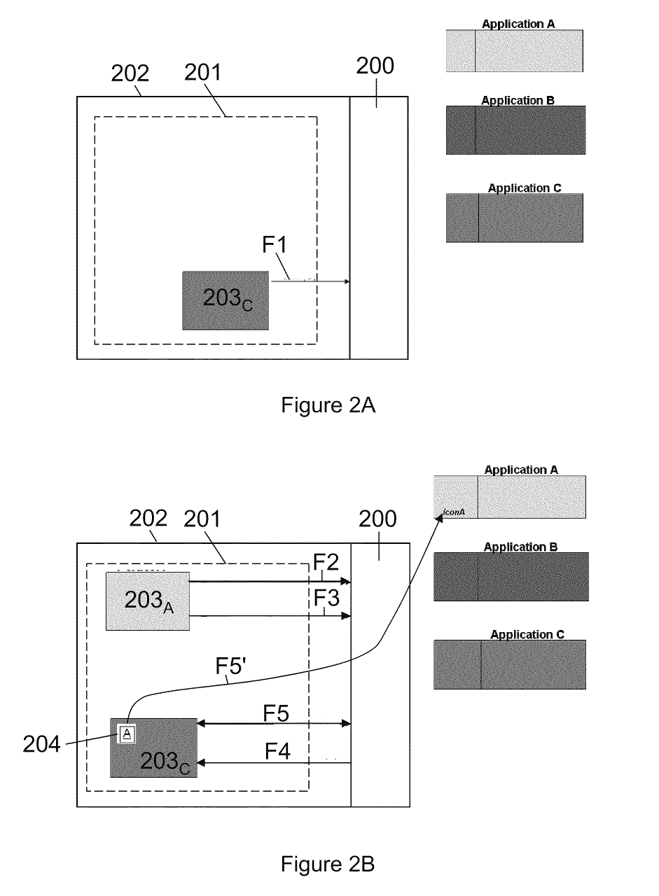

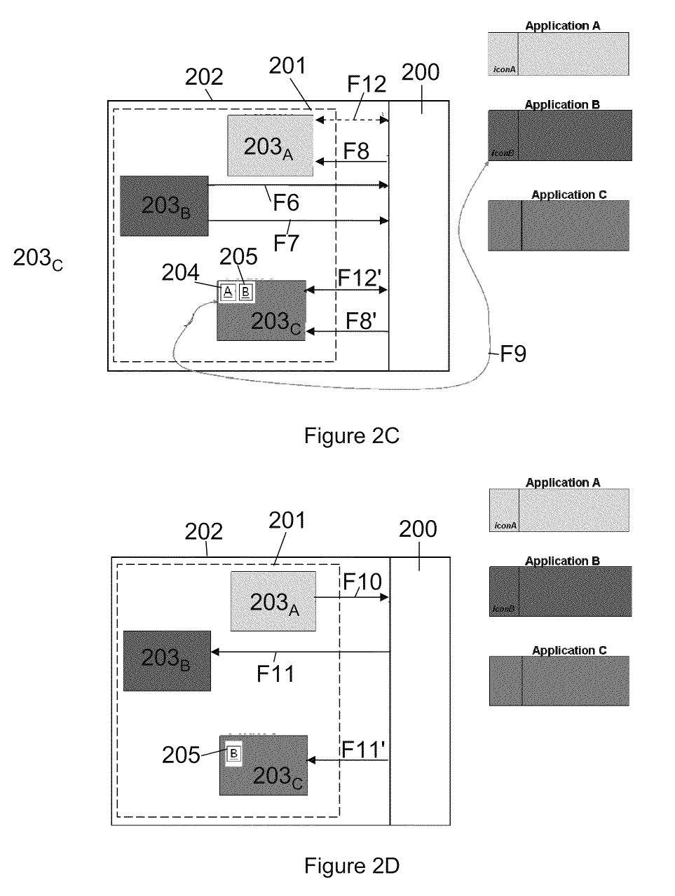

As shown in FIGS. 2A to 2D, the step in which an application newly activated/executed on a web page is subscribed to a service of at least one other application hosted on the same web page 201 of a browser 202 is effected by an application management entity 200.

To reduce the involvement of users in the inter-application communication process, the following subscription mechanism is used:
when an application subscribes to an event and/or data, or more generally to a service of another application, a service adapted to generate data and/or at least one output event, it can provide a URL of an icon that is significant of the operation that it executes dynamically (or even at the request of the user), taking into account as input parameters the events and/or the data generated; and
the other application is executed on the same web page and the management entity is then in a position to recover this URL and to include this icon in its documents.

In the FIG. 2A example, three applications A, B, and C are considered that are to be executed on the same web page 201 of a browser 202.

The application C is chronologically the first application to be executed on the web page 201 via a portlet 203_{C}. This portlet 203_{C} is then registered (arrow F1, step 100) with the application management entity 200. This illustrative example assumes that the application C generates events of eventType type with data of dataType type via its portlet 203_{C}.

Then, and as shown in FIG. 2B, an application A is executed in a portlet 203_{A} by the same user on the web page 201 of the browser 202, said application A then being registered (arrow F2, step 101₁) with the application management entity 200, subscribing to at least one service of at least one other application.

During this subscription stage, the application A supplies (arrow F3, step 101₂) the management entity 200 with the relevant type of data and/or events, i.e. those liable to serve as input parameters for the execution of at least one of its operations (services, processes, etc.). It also provides a link (for example a URL (uniform resource locator)) pointing (arrow F3) towards the operation that is to be executed dynamically as soon as a parameter (data and/or event) value to which it has subscribed is generated.

It further provides (arrow F3) a URL of an icon that is significant in relation to the action to be undertaken and corresponding to that description. At this stage the entity 200 detects if there is an association to be created between the data/events generated by the portlet 203_{C} and the data/events liable to serve as input parameters for the execution of operations of the portlet 203_{A} (step 101₃).

In FIG. 2B, for example, it is assumed that the portlet 203_{A} subscribes (arrow F3) to dataType data, therefore supplies the URL of the callback action, and also supplies the URL of an iconA@appA icon.

Following the step of subscription of the application A, the management entity 200 (also known as the communication manager) notifies (arrow F4) execution of the application A in the portlet 203_{A} to the application C via its portlet 203_{C}.

This informs the application C that a new application (application A) is being executed on the same web page 201 of the browser 202. The application C can then recover (arrow F5) from the application management entity 200 via its portlet 203_{C} a list L of applications that subscribe to the data and/or events (i.e. more generally services) that it generates, and thus in the specific example to dataType data and eventType events.

The portlet 203_{C} in which the application C is executed realizes that the portlet 203_{A} in which the application A is executed can react to events that it generates. It then downloads (arrow F5) the icon 204 at the URL iconA@appA. That URL is supplied by the portlet 203_{A} in the step described by the arrow F3 and recovered (arrow F5) at the same time as the list L.

In one particular simplified embodiment the application management entity 200 downloads the icon 204 and creates in the portlet 203_{C} all the communications links to be set up. To this end, the developer of the portlet 203_{C} indicates the position at which to display this icon by means of an html beacon. In this embodiment, the application management entity 200 therefore manages the lifecycle of the communications link represented by the icon 204 (which is deleted when the portlet 203_{A} disappears).

The portlet 203_{C} then displays in an area reserved for its man-machine interface (MMI) an icon representing a communications link set up with the application A of the portlet 203_{A} (step 103) so that once that communications link is set up either the user can click (for example with a mouse or a stylus) on the icon to trigger execution of a specific operation that will take account by way of input parameters of at least one data and/or event value generated by the application C and to which the application A has subscribed previously, or the operation of the application A will be triggered dynamically as soon as the application C has generated a data and/or event value to which the application A has subscribed beforehand.

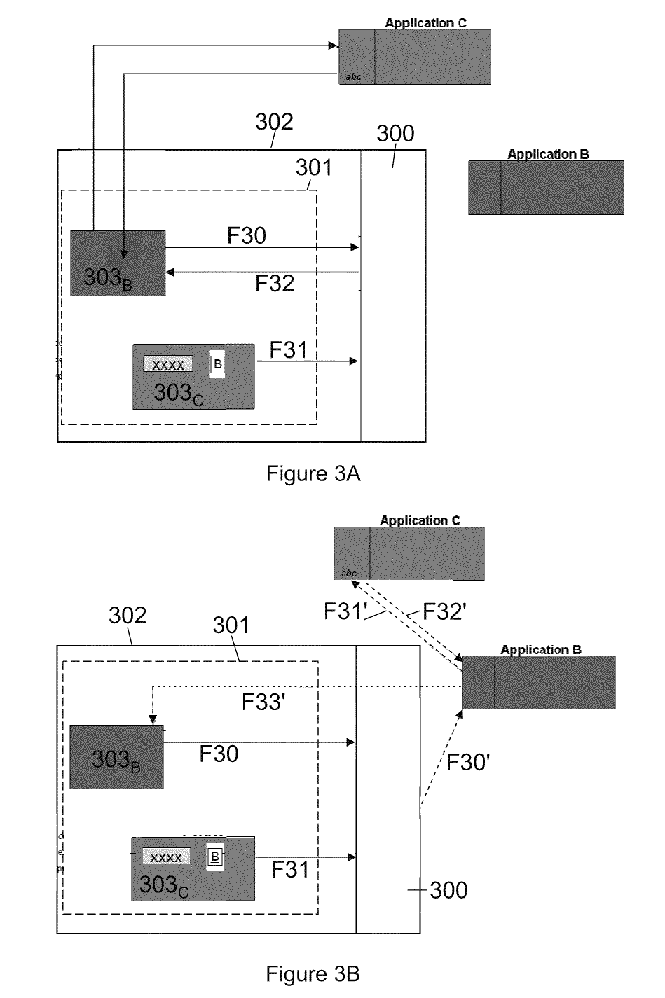

This aspect specific to communication between applications is described in more detail below with reference to FIGS. 3A and 3B.

FIG. 2C describes the steps that follow those that are described above in detail with reference to FIG. 2B.

Thus, referring to FIG. 2C, assume that the user executes a new application B in a portlet 203_{B} of the same web page 201 of the browser 202.

The portlet 203_{B} of the application B is then registered dynamically (arrow F6) with the application management entity 200. For each subscription that it effects, it also supplies the type of relevant data and/or events, the URL pointing to the operation that it is liable to execute using by way of input parameter a value of the data and/or events to which it is subscribed, and a URL of an icon representative of the above-mentioned operation.

In the remainder of the FIG. 2C example, the portlet 203_{B} subscribes (arrow F7) via the application management entity 200 to dataType data and thus provides the URL of the callback action and also the URL of the iconB@app icon.

Once the application B has been registered with the application management entity 200, said entity notifies (arrows F8 and F8′) the applications A and C of activation of the application B on the web page 201 via their respective portlets 203_{A} and 203_{C}.

The portlets 203_{A} and 203_{C} thereafter have access to information as to the presence of application B in the web page 201, with the result that each then recovers a list L of subscriptions that application B has undertaken in relation to the data of predetermined type and the events of predetermined type (or more generally the services) that they are liable to generate—in the case of the portlet 203_{C} events of evenType type and data of dataType type.

In the FIG. 2C example, application B does not subscribe to any service of application A, i.e. here none of the data and/or events generated on exit from a service rendered by the application A is liable to serve as an input parameter for an operation (service, process, etc.) executed by the application B.

The portlet 203_{C} realizes dynamically that the portlet 203_{B} can react to events and/or data that it generates on exit from the service or services that it uses, with the result that it then downloads the icon 205 representative of the application B via the URL iconB@appB recovered in the step represented by the arrow F8′. This icon 205 supplied by the portlet B in the step represented by the arrow F7 is then displayed in a predetermined area of the MMI offered to the user by the portlet 203, for example beside the icon 204 representing the application A. Thus it then suffices for the user to click on the icon representing the application B contained in the portlet 203_{C} for the application C to send data or an event that it generated previously to the application B via the portlet 203_{B} so that application B can execute a predetermined operation (service, process, etc.) taking into account as input parameter said data and/or said event sent by said application C.

In one variant of the above-mentioned mechanism of the invention, action of the user on the icon 205 representing the application B situated in the MMI of the portlet 203_{C} is clearly not necessary. It is possible to envisage that in such a variant, as soon as the application C generates a value for data and/or an event to which the application B has previously subscribed, the application C, via its portlet 203, automatically transmits that value to the application B via the application management entity 200, so that the application B can dynamically execute said predetermined operation (service, process, etc.), taking account of said data and/or said event sent by said application C as input parameter(s).

The mechanism of communication between applications sharing the same web page is described in detail below with reference to FIGS. 3A and 3B.

In the remainder of the description of the scenario described by way of illustrative example with reference to FIGS. 2A to 2C, there is described below with reference to FIG. 2D how the context of the subscriptions between applications of the same web page 201 can be maintained between the various applications by said application management entity 200 once a user deactivates or disconnects an application executed in the web page 201.

As shown in FIG. 2D, a user deactivates/disconnects the application A by closing the window of the portlet 203_{A} on the web page 201 of the browser 202.

The application management entity 200 is then automatically notified by the portlet 203_{A} (as represented by the arrow F10).

The application management entity 200 notifies the portlets 203_{B} and 203_{C} of the disconnection of the portlet 203_{A} by sending each of them a disconnection message (arrows F11 and F11′).

The portlet 203_{C} in which the application C is executed is then updated dynamically by eliminating from its MMI the icon 204 representing the application A.

In one particular simplified embodiment, it is the application management entity 200 that directly eliminates the icon 204 in the MMI of the application C.

To illustrate the contribution of this mechanism, consider a concrete example in which directory, telephone, email and instant messaging (IM) applications cohabit on the same Internet browser web page.

Assume now that a user loads a contact into the directory and that the telephone, email and IM applications have previously subscribed to the “contact” data produced by the directory application.

The operations that they can trigger with the “contact” data as an input parameter are, for example: to call the contact, to send an electronic mail to the contact, to open a dialogue box to initiate a call with the person to which this “contact” data refers.

By means of the communications method of the invention, the telephone application provides the application management entity 200 during the subscription steps with an icon representing a telephone call. The other applications do likewise with icons representing sending email and instant messaging.

The directory application recovers from the management entity information whereby the telephone, email, and instant messaging applications have subscribed to the “contact” data and adds the above-mentioned icons to the MMI of its portlet (arrows F3, F5′ and F12, F12′ in FIGS. 2B and 2C), and on clicking on one of these icons the directory application publishes a unicast event for directly triggering in the application concerned the operation associated with the icon (calling, sending e-mail or initializing the conversation).

An advantage of this type of mechanism is that it is more intuitive for the user than the simple “drag and drop” mechanism. At the same time, this mechanism leaves the user in control of their space by avoiding triggering more than one portlet at a time.

The principle of communication between applications hosted on the same web page 301 of a browser 302 via an application management entity 300 of the invention is described below with reference to FIGS. 3A and 3B.

Publication causes other applications of the same web page to react to the result of execution of a service by another application and by communicating at least one parameter corresponding to a data and/or event value produced thereby application to serve them as an input parameter for executing a specific operation.

Applications can publish parameters, such as data and/or events.

For security reasons there are four types of publication, namely PUBLIC, UNICAST, GROUP, and PRIVATE.

If a publication by an application is a PUBLIC publication, then all applications that monitor the event or data type corresponding to that publication will be in a position to react to it.

If a publication is a GROUP publication, then only applications belonging to the same group as the application publishing its data and/or events will be in a position to react.

For example, it will be equally possible to secure application communication by conditioning execution of an operation of a first application on transmission of a parameter (of data or event type) with a value that has been generated by a second application belonging only to the same group as said first application.

If a publication is a PRIVATE publication, then only the module itself (which generated this type of event or data) reacts.

If it is a UNICAST publication, then a generated event will be intended only for a specific application posted on the web page.

In all four of these situations (PUBLIC, GROUP, PRIVATE, UNICAST), data/event type mapping generated with the data/event types to which other applications subscribe is effected in the entity 200 (step 102₁).

FIG. 3A shows the mechanism for unicast publication of events and data (between two applications B and C);
Step 1 (arrow F30): a user loads the application B that subscribes to data of the dataType type; to this end the application B supplies a call back function (callBack) that can be a Javascript function or a URL (this occurs in the initialization step);
Step 2: the user clicks on the icon B in the portlet C, and the portlet C therefore publishes (arrow F31) the event with the publication type parameter set to UNICAST, the type of data published set to dataType, the URL at which this data is found to be set to abc@appC, and the destination service set to B (beginning of step 102).

If the call back function of step 1 is a Javascript function:
Step 3: the management entity 300 routes the publication to the portlet B (arrow F32) and sends it the URL that points to the data transmitted by C (abc@appC) (after step 102);
Step 4: the module B downloads the URL content (arrow F33);
Steps 5 and 6: the module B is updated (arrows F35 and F36) as a function of the data received.

If the call back function supplied in the step 1 is a URL, the corresponding scheme is as follows (FIG. 3B):
Step 3′: the management entity 300 routes the publication to the portlet B (arrow F30′) and sends it the URL that points to the data transmitted by C (abc@appC) (after step 102);
Step 4′: the module B downloads the content of the URL (arrow F31′);
Steps 5′ and 6′: the module B is updated (arrows F31′ and F33′) as a function of the data received.

On the path (F30′, F31′, F32′, F33′) the portlet B is loaded completely, in contrast to the path (F32, F33, F35, F36) on which the portlet reacts by executing a script only in the presentation layer.

A pivot semantic between the applications is indispensable if the modules are to be kept independent of each other. That semantic can be described with formalisms such as: microformat, RDF, OWL, etc.

In this embodiment, microformats such as hCard and hCalendar have been used. The basic micro-formats consist of a predefined XML beacon to be inserted in an HTML page, and modern browsers are able to interpret them.

In the context of the present invention, the XML beacons are not integrated into the HTML code but stored directly in a separate file that is accessed by means of a URL.

For example, hCard is a data format for representing persons, companies, organizations and places. It enables a machine to extract the name, forename, telephone number, email address, and address of a person, company or organization.

Appendix 1 gives an example of an hCard describing the person “Mr Dupont”.

This representation common to all applications hosted on the same web page advantageously enables homogeneous exchange of data. For example, a telephone application that recovers the above-mentioned hCard (published by a directory application, for example) knows that the data represents a person and that it can recover a corresponding telephone number (to call the person) at the beacon <span class=“tel”>.

APPENDIX 1

| - | <card> | |
|---|---|---|
| | - | <div class=“vcard”> |

| | |
|---|---|
| - | <span class=“fn”> |

<span class=“given-name”>Jean</span>
<span class=“family-name”>Dupont</span>

| | |
|---|---|
| | </span> |
| | <img class=“photo” alt=“Jean Dupont” src=“photo.gif”/> |
| - | <div class=“org”> |

FT/NSM/RD/BIZZ/PMX/SLA:Services en Ligne et Annuaires pour les entreprises

| | |
|---|---|
| | </div> |
| - | <span class=“tel”> |

<span class=“type”>work</span>
<span class=“value”>02 31 75 90 05</span>

| | |
|---|---|
| | </span> |
| - | <span class=“tel”> |

<span class=“type”>fax</span>
<span class=“value”>02 31 73 56 26</span>

| | |
|---|---|
| | </span> |
| | <a class=“email” href=“mailto:jean.dupont@orange-ftgroup.com”>jean.dupont@orange-ftgroup.com</a> |
| | <a class=“url” href=“xmpp:”/> |
| - | <span class=“adr”> |

<span class=“street-address”>42 rue des Coutures</span>
<span class=“postal-code”>14000</span>
<span class=“locality”>Caen</span>
<span class=“country-name”>fr</span>

</span>

</div>

</card>

1. A method of communication between a first application and at least one second application accessible on an Internet browser page, the method comprising:
a dynamic subscription step of said first application subscribing dynamically to at least one service of said at least one second application;
an execution step of said first application executing at least one operation taking account of a value of at least one parameter generated by the execution of said at least one service and sent by said second application to said first application.

2. A method according to claim 1, the method further comprising a prior step of said second application sending a first list to an application management entity, which first list associates each service offered by said second application with at least one type of parameter for which a value will be generated on execution of said service.

3. A method according to claim 2, wherein said subscription step comprises the following sub-steps:
registering said first application with an application management entity;
said first application sending said application management entity a second list of parameters respectively associated with at least one operation liable to be executed by said first application;
said management entity creating a third service subscription list by matching parameter types contained in said first and second lists, which third list associates each service from said first list with at least one operation liable to be executed by said first application.

4. A method according to claim 1, the method further comprising a step of creating a communications link between said first and second applications, which communications link is activated from the second application to trigger the execution of said operation by said first application following execution of said service by said second application.

5. A method according to claim 4, wherein said link is of the remote function call type taking account of a value of said parameter generated on execution of the specific service of said second application.

6. A method according to claim 4, wherein said link is an element of a man-machine interface specific to said second application and by means of which a user of said second application can interact to trigger the execution of said operation via said first application.

7. A method according to claim 1, wherein in said dynamic execution step it is verified that the type of said at least input parameter of said operation corresponds to the type of at least one parameter generated on execution of a service of said second application to which said first application subscribes.

8. A system for communication between a first application and at least one second application hosted on the same Internet browser page, the system comprising:
means for dynamic subscribing said first application to at least one service of said at least one second application;
means for executing by said first application of at least one operation taking account of a value of at least one parameter generated by the execution of said at least one service and sent by said second application to said first application.

9. An entity for managing at least one first application and at least one second application hosted on the same Internet browser page, the entity comprising:
means for referencing each said first application and at least one second application;
means for storing a first list associating each service offered by said second application with at least one type of parameter for which a value will be generated on execution of said service, said second application sending said first list to said entity;
means for storing a second list of parameters respectively associated with at least one operation liable to be executed by said first application, said second list being sent to said entity by said first application;
means for creating a third service subscription list which associates each service from said first list with at least one operation liable to be executed by said first application, said creation means being adapted to match the parameter types contained in said first and second lists.

10. An entity according to claim 9, the entity further comprising:
means for receiving a value of at least one parameter generated by said second application executing said at least one service; and
means for sending said value to said first application for dynamic execution of said at least one operation taking account of said value.

11. A computer program product downloadable from a communications network and/or stored on a computer-readable information medium and/or executable by a microprocessor, the computer program product comprising code instructions for the execution of a communications method according to claim 1 when it is executed on a computer.
